(19) United States
(12) Patent Application Publication
(10) Pub. No.: US 2026/0249302 A1
(43) Pub. Date: Aug. 27, 2026

(54) ROTOR TOOL FOR A COMMINUTING MACHINE AND ROTOR FOR A COMMUTING MACHINE FOR TOWED AGRICULTURAL OR FORESTRY MACHINE

(71) Applicant: Seppi M. SPA AG, Mezzolombardo (IT)

(72) Inventor: Lorenz SEPPI, Mezzolmbardo (IT)

(73) Assignee: Seppi M. SPA AG, Mezzolombardo (IT)

(21) Appl. No.: 18/730,328

(22) PCT Filed: Jan. 24, 2023
(86) PCT No.: PCT/EP2023/051621

§ 371 Date: Jul. 19, 2024

(30) Foreign Application Priority Data
Feb. 2, 2022 (IT) 102022000001781

(51) Int. Cl. B02C 18/18

(52) U.S. Cl. CPC B02C 13/2804; B02C 13/06; B02C 13/18; B02C 2013/2808; B02C 2013/2812; B02C 18/18

(57) ABSTRACT

A tool (200) which is intended for a tool-holder (100) and has a tool body (201), on which a cutting edge (203) is arranged in the upper front central part, and the tool body (201), has at least two partition walls (102) which form a channel (103), the tool body (201) has, in the direction of rotation of the tool, a slot (204) for insertion on a partition wall (102) and also a through-bore (204) for the fastening of the tool (200) on a tool-holder housing, which is arranged on the rear side of the tool-holder rotor (100) or is arranged directly on the tool-holder rotor (100), and wherein the body of the tool takes up the entire width of the channel.

### BACKGROUND OF THE INVENTION

The present invention relates to a tool for a chopping and cutting machine for a towed agricultural or forestry machine, in particular a mower, commuting machine, ground-working machine and a tool rotor for a chopping machine.

### TECHNICAL AREA

Machines used to crush and cut material, such as biomass, can have different configurations for different purposes. Different tools require different cutting depths and may require different types of tool rotors.

### STATE OF THE ART

In general, two types of tool holders are known for comminuting machines and/or milling machines. The first type has a support surface on which the tool is attached with its surface opposite to the cutting direction, for example with a screw. This type of tool holder is known, for example, from DE 2013 110289 A1 . This type of tool holder brings with it the problem that the tool is exposed to impacts and damage with its entire body in the cutting direction.

A second type of tool holder has a seat into which the tool is inserted, which consists of a first surface arranged in the cutting direction and a second surface on which the tool is fixed with its surface opposite to the cutting direction. Such a tool holder is known, for example, from EP 1 693 110. With this type of housing, the tool is inserted into the housing resting on the housing base and then secured with a screw.

In addition, a plurality of means are known to adjust the size of the material to be processed, e.g. biomass, soil, waste, etc.

A control ring for cutting and/or chopping, which comprises a ring for controlling the cutting depth, is known from US 2017/079219. This ring has a first end and a second end and a tool holder is arranged between the first and the second end, wherein the ring is connected to the back of the tool holder and is arranged at least partially in front of the cutting tool body.

The described ring must be mounted on the rotor to which the tool holders are attached; the material to be shredded can travel to the side of the cutting tool or over the cutting tool.

CA2531985 describes a tubular cylindrical base for cutting heads. On the cylindrical base, a series of cutting tools are firmly mounted on the outer surface. Each of the cutting tools is connected to a guard mounted on the cylindrical surface.

The described ring must be mounted on the rotor to which the tool holders are attached; the material to be shredded can travel to the side of the cutting tool or over the cutting tool.

Comminuting machines often have the problem that the shredded material is not shredded evenly and after passing through the comminuting machine, biomass or similar remains that is not cut and/or shredded evenly. This is particularly due to the cutting depth and/or the deflection of the shredded material, which can be guided past the side or top of the cutting tool.

This problem causes a number of disadvantages. Problems can arise, especially if the cutting depth is too great and the force used is not sufficient to shred the material. Secondly, it can be problematic if the chopped material is too long, for example when composting biomass, which can take longer.

From RU 2666547 C1 a stone crusher for comminuting earth is known. The tools for rock crushing/soil processing are arranged on the conical tool holder rotor.

This problem causes a number of disadvantages. Problems can arise, especially if the cutting depth is too great and the force used is not sufficient to shred the material.

Since ES 2 606 775, a system for agricultural machinery has been known which comprises a comminution chamber in which at least one rotor with cutting blades and one or more conveyor units are arranged. On the lid, which forms the comminution chamber, a series of knives are arranged in a comb-like arrangement, with the tools arranged on the rotor. The comminution chamber is relatively large and therefore allows a cutting zone at the base of the tools. The cutting zone is only the outer area in which the cutting edge of the tool is located. As already mentioned, the cutting depth is not limited in this publication, especially not the width and height of the cutting zone. This can result in the material not being crushed sufficiently.

From WO2021005090 a tool holder rotor for biomass shredders and the like is known, which has a cylindrical body, on the outer surface of which a plurality of tool holder seats are arranged, and in the respective tool holder seat a tool is arranged, which is formed by a tool body and a cutting edge forming the cutting zone, wherein in the cutting direction a deflector arranged essentially orthogonally to the tool and essentially centrally to the cutting zone is connected to the tool holder seat. The tool seat and the tool body are subject to wear and there is a risk of damage, which could lead to the tool body breaking, for example, even if the cutting edge is still usable.

EP 2 255 882 describes a shredding machine with a shredding unit consisting of a tool-carrying shredding rotor, an adjustable counter-blade and a screen basket, wherein the comminution rotor is equipped with tool holders in which freely swinging or overload-protected fixed tools can be accommodated. The comminution machine is built for stationary use and therefore not designed to be operated in motion.

From DE 10 2007 043687 a tool is known which is attached to a rotor. The rotor has no means to direct the material to be cut to the tool.

### SUMMARY OF THE INVENTION

The object of the present invention is to realize a tool for a comminution machine with a tool holder rotor for a towed agricultural or forestry machine, in particular a mower, comminution machine, ground-working machine and the like, which ensures uniform cutting of biomass and the like by avoiding excessive cutting depths that could lead to jamming of the machine, thereby reducing the service life of the agricultural or forestry machine and increasing the life of the tool and the tool holder rotor, in particular the tool bearing housing.

This object is achieved by a tool for a comminution machine with a tool holder rotor for a towed agricultural or forestry machine, in particular a mower, shredder, ground-working machine and the like according to the claims.

A tool rotor for a shredder for a tool for a comminution machine with tool holder rotor for a towed agricultural or forestry machine, in particular a mower, shredder, ground-working machine and the like and the like is proposed, which consists of a cylindrical body on the outer surface of which tool seats and channel-forming walls are arranged, wherein a row of tools is deposited on the tool rotor and the tool has a slot into which a channel-forming wall is inserted.

The tool for a tool holder rotor has a tool body on which a cutting edge is arranged in the front top center and the tool body has an insertion slot and a through hole in the front center of a partition wall in the direction of rotation for fastening the tool to a tool holder housing, preferably arranged at the rear or directly on the tool holder rotor, wherein the insertion slot is arranged essentially in the middle part in alignment with the cutting edge of the tool and that at least two partition walls form a channel. Advantageously, an insert is arranged on the upper edge of the tool body, which forms the shoulders from a harder material than the tool body. This extends the life of the tool as this is the area that is most subject to wear.

The tool according to the invention is inserted with the slot into a wall arranged on the tool holder rotor. This wall has a dual function. The first function is to limit the flow of material to the tool and secondly to create a channel with a second wall in which another wall and a tool are arranged. These channels regulate the flow of the material to be processed to the tool. Since the tool with its body preferably occupies the entire width of the channel and thus does not allow any material flow to the side of the tool, the material flow is directed towards the cutting edge of the tool. In addition, the shoulders of the tool body are stressed and wear out.

### DESCRIPTION OF THE DRAWINGS

Further characteristics and details of the invention emerge from the claims and from the following description of a preferred, non-restrictive embodiment which is illustrated in the accompanying drawings, wherein

FIG. 1 is a perspective view of a tool rotor segment according to the invention,

FIG. 2 is a side view of a rotor segment of a tool holder according to the invention,

FIG. 3 is a front view of a tool holder rotor segment according to the invention,

FIG. 4 is a cross-section of FIG. 3 along CC according to the invention,

FIG. 5 is an enlarged front view of a tool holder rotor segment according to the invention,

FIG. 6 is a perspective view of a tool according to the invention,

FIG. 7: Front view of a tool according to the invention,

FIG. 8: Top view of a tool according to the invention,

FIG. 9: Front view of a tool according to the invention,

FIG. 10 is a cross-section of FIG. 9 along AA, and

FIG. 11: Shows a side view of a tool according to the invention.

### DETAILED DESCRIPTION OF THE INVENTION

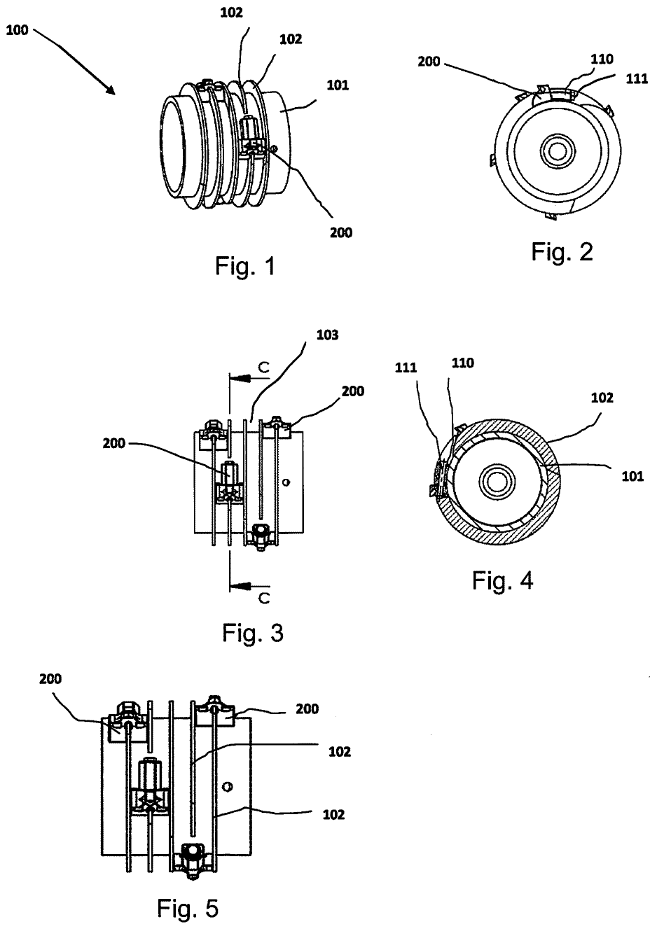

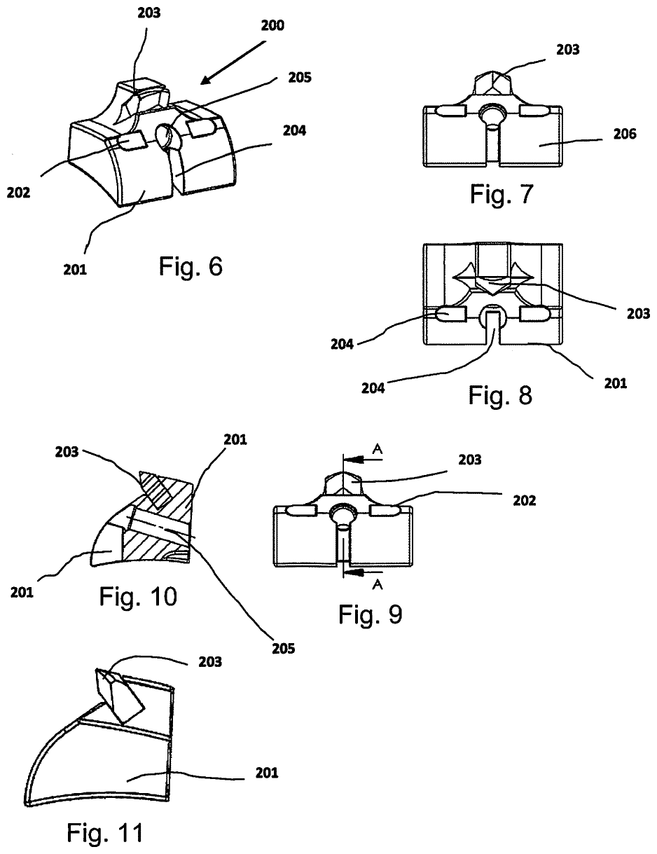

A tool holder rotor according to the invention is designated by the reference number 100 in FIG. 1. The tool holder rotor 100 has a cylindrical body 101 on which a series of walls 102 are arranged, which extend substantially parallel to each other and form channels 103. The walls 102 partially surround the cylindrical body of the tool holder rotor 101. A tool 200 is pushed onto a wall having a central slot into which the wall 102 is inserted. The tool 200 is fixed by means of a screw 111 to a tool holder housing 110 which is located on the rotor 100 of the tool holder and/or directly on the rotor 101 of the tool holder. Advantageously, a form fit is formed between the tool 200 and the wall 102.

Advantageously, the width of the channel corresponds to half the width of the tool and the wall inserted into the slot 203 of the tool advantageously forms a side wall of a subsequent channel 103.

The tools 200 are advantageously arranged laterally offset from one another by half the width of the tool plus the width of a wall 102.

In one embodiment, multiple tools 200 may be arranged on the same circumference of the tool body.

The tool 200 has a tool body 201. A cutting edge 203 is arranged in the upper front part of the tool body. The front side is the side in the direction of rotation of the tool.

Also on the tool body 201, a slot 204 is arranged in the front direction for inserting the tool on a wall 102. In addition, the tool body has a through hole 205 for fastening the tool 200 to a seat 110 or directly to the cylindrical body 101 of the tool holder rotor 100 by means of a screw 111.

The cutting edge 203 and the slot are aligned with each other. This ensures that the flow of the material to be machined/cut is adjusted from the wall 102 to the cutting edge 203.

Advantageously, two inserts are arranged on the tool body on the upper front side of the tool body 201 laterally on the shoulders of the tool body 201. The flow from the channel 103 is redirected through the tool body, in particular from the shoulders on which the inserts 202 are arranged, towards the cutting edge 203. The inserts 202 are arranged below the cutting edge of the tool.

Advantageously, two tools 200 are partially arranged in one channel 103, i.e. one tool is arranged in two channels 103.

The tool rests radially on the rotor 100 and thus adapts to the shape of the cylindrical tool holder rotor body 101.

The wall 102 which is received by the slot 204 of the tool body ends with a surface which runs parallel to the receptacle of the tool holder.

The tool 200 in the channel 103 is shaped so that the sides form a radially deflecting shape, whereby the material is conveyed or squeezed against counter knives mounted on the frame which receives the tool holder rotor.

The slot 204 and the back surface of the tool 200 are shaped to form a positive fit with the tool holder and the wall 102.

Finally, it is clear that additions, modifications or variants which are obvious to a person skilled in the art can be applied to the tool and tool holder rotor described so far without violating the scope of the appended claims.

### List of Reference Numbers

100 Tool holder rotor
101 Cylindrical tool holder rotor body
102 Wall/Partition wall
103 Channel
110 Tool holder housing
111 Screw
200 Tools
201 Tool body
202 Inserts
203 Tool cutting edge
204 Slot
205 Through hole

1. A tool for a tool holder rotor with a tool body on which a cutting edge is positioned in the upper front central part and the tool body wherein at least two partition walls form a channel and the tool body has a central slot in the direction of rotation of the tool for insertion on one of the partition walls and a through hole for fastening the tool to a tool holder housing arranged on the rear of the tool holder rotor or directly on the tool holder rotor, and wherein the tool with its body takes up the entire width of the channel.

2. The tool for a tool holder rotor according to claim 1, wherein the slot for insertion is arranged substantially centrally below the cutting edge of the tool.

3. The tool for a tool holder rotor according to claim 1, wherein the tool body consists of a metallic material and at least two inserts made of a harder material than the tool body are arranged on the tool body at the upper side region of the tool body.

4. A tool holder rotor for chopping machines consisting of a cylindrical body on the outer surface of which at least three partitions are positioned, which form channels, a series of tools are positioned on the tool holder rotor, the tool having a slot in a front part into which one of the partitions is inserted and one of the series of tools with its body occupying an entire width of one of the channels.

5. The tool holder rotor according to claim 4, wherein the tool is a tool according to claim 1.

6. The tool holder rotor according to claim 4, wherein the tools are arranged laterally offset from one another by half the tool width plus the width of one of the at least three partitions.

7. The tool holder rotor according to claim 4, wherein the tool is fastened by means of a screw to a tool holder housing located on the tool holder rotor or directly to a body of the tool holder rotor.

8. The tool holder rotor according to claim 4, wherein a positive connection is realized between the partition and the tool.

9. The tool holder rotor according to claim 4, wherein two tools are partially arranged in one of the channels.

10. The tool holder rotor according to claim 4, wherein the slot and a back surface of the tool are shaped such that they form a positive connection with the tool holder and one of the at least three partitions.

11. The tool holder rotor according to claim 4, wherein one of the series of tools in one of the channels is shaped so that sides of the tool form a radially deflecting shape, whereby material is conveyed or squeezed against counter-blades which are mounted on a frame which receives the tool holder rotor.

12. The tool holder rotor according to claim 4, wherein one of series of tools rests radially on the tool holder rotor and thus adapts to the shape of the cylindrical tool holder rotor body which is cylindrical.

13. The tool holder rotor according to claim 4, wherein one of the at least three partitions which is received by the slot of the tool body ends with a surface which extends parallel to a receptacle of a cylindrical tool holder rotor body.
